(19) United States
(12) Patent Application Publication
(10) Pub. No.: US 2022/0357772 A1
(43) Pub. Date: Nov. 10, 2022

(54) Communications Device Housing

(71) Applicant: FUTURENOVA LTD., Essex (GB)

(72) Inventor: Michael CASEY, Essex (GB)

(21) Appl. No.: 17/779,206

(22) PCT Filed: Nov. 27, 2020
(86) PCT No.: PCT/EP2020/025544

§ 371 Date: May 24, 2022

(30) Foreign Application Priority Data
Nov. 27, 2019 (GB) 1917278.2

(51) Int. Cl. G06F 1/16; H04B 1/3888; H04M 1/18; H04M 1/02

(52) U.S. Cl. CPC G06F 1/1626; H04B 1/3888; H04M 1/185; H04M 1/0235; G06F 1/1656; G06F 2200/1633

(57) ABSTRACT

The present invention relates to the field of communications device housings, namely housings for the support and protection of hand-held electronic devices having data input features and video screens. In particular, the present invention relates to housings for communications devices such as smartphones, for example, which housings protect the communications devices and can be easily cleaned. The housing consists of two interacting housing parts to protect a smartphone therein, wherein the first housing part comprises sliding channels (35) into which tabs (34) of the second housings slide when the two housings are slit together to be closed. The end of the sliding channels (35) comprise a detent member (36) into which the tabs (34) engage when the housing is closed. A locking mechanism (29) is provided which fixes the both hosing parts when closed.

### FIELD OF INVENTION

The present invention relates to the field of communications device housings, namely housings for the support and protection of hand-held electronic devices having data input features and video screens. In particular, the present invention relates to housings for electronic devices such as smartphones, for example, which housings protect the electronic devices and can be easily cleaned with infection control chemicals.

### BACKGROUND TO THE INVENTION

A smartphone—the term being derived from a contraction of smart and telephone—is a class of a combined mobile phone and a multi-purpose mobile computing device. Smartphone are distinguished from feature phones by their advanced hardware capabilities and extensive mobile operating systems, which facilitate wider software, internet capability (including web browsing over mobile broadband), and multimedia functionality including data-transfer, video, etc., together with traditional core phone functions such as voice calls and text messaging. Smartphones typically include various sensors that can be utilised by their software, such as a GPS position determining sensors, proximity sensing and pressure sensing, and support wireless communications protocols such as Bluetooth™. Equally, a smartphone can also be considered as a mobile computer with a touchscreen display, circuitry and battery in a single, hand-size, hand-held device. Certain smartphones can include physical buttons for basic features such as speaker volume and power, and ports for network communications and battery charging. Smartphones are typically significantly smaller than tablet computers and laptop computers, typically being of a general cuboid form with a thickness or depth of 0.25″-0.4″ (6.3 mm-10.1 mm) and a screen generally less than 7″ (18 cm) as measured diagonally.

Present day functionality of smartphones is substantially determined through a touch screen, namely almost all instructional and interactional input on smartphones is provided through the touch screen, many of which can interpret complex gestures using multi-touch; the use of an operator's finger or a stylus can be employed to use the device and input or amend data/script. This can permit a user to navigate easily and type with a virtual keyboard on the screen. Such systems respond to a touch of the screen rather than a depression of a keyboard or movement of a “mouse”, which allows integrated hand-eye operation, a natural use of the somatosensory system. The smartphone's interaction techniques enable the user to move the content up or down by a touch-drag motion of the finger. For example, zooming in and out of web pages and photos can be performed by the placement of two fingers on the screen and spreading them farther apart or bringing them closer together whilst remaining in contact with the screen, commonly referred to as “pinching”. Scrolling through a long list or menu can be achieved by sliding a finger over the display from bottom to top, or vice versa to go back. In either case, the list moves as if it is pasted on the outer surface of a wheel, slowly decelerating as if affected by friction. In this way, the interface simulates the physics of a real object.

Touchscreens usually come in one of two forms: Resistive touchscreens are passive and respond to pressure on the screen. They allow a high level of precision, useful in emulating a pointer, as is common in the use of smartphone computers, but may require calibration. In view of the high levels of resolution possible, a stylus or fingernail is often used, although this also means that they are less suited to multi-touch functioning. In contrast, capacitive touchscreens tend to be less accurate, but more responsive than resistive devices. However, because they require a conductive material, such as a fingertip, for input, they are not common among stylus-oriented devices, but are prominent with consumer devices. Finger-driven capacitive screens do not currently support pressure input.

A smartphone's size can vary considerably, but marketplace trends can determine current preferred dimensions. For example, the Apple iPhone 8 has a screen-to-body ratio of 86% and a screen size of 6.5″,—the same as the Honor 8X—with corresponding dimensions of the Samsung Galaxy Note 9, LG V40 ThinQ being 84% and 6.4″. It is notable that a one-time ethos of Steve Jobs, a founder of Apple was that a 7-inch (17.5 cm) screen would be “too small to express the software”.

A smartphone display can be responsive to other controlling factors: an ambient light sensor can cause screen brightness to vary; a 3-axis accelerometer can be deployed to determine smartphone orientation and switch between portrait and landscape modes. Certain devices enable screen rotation in all four orientations, including upside-down. Consequently, a device may have no intrinsic “native” orientation; only the relative position of the home button changes.

The use of smartphones, in modern day life is ubiquitous; not only for social reasons but increasingly for business reasons and many employers provide smartphones as part of a standard employee package. However, smartphones—whether an iPhone or not—are electronic devices which need to be protected from damage in use, whether from mishandling including being dropped onto hard surfaces, splashed with water, chemicals etc. and they need to be capable of being cleaned with harsh infection control chemicals and wipes—especially in healthcare facilities, for example, whilst, of course, retaining their functionality. There are a number of cases for smartphones like the Apple IPhone®, Samsung Galaxy® and other smartphones commercially available.

The commercially available cases for smartphone devices may not meet some of the needs of consumers, and may be more difficult and/or costly to manufacture than is desirable. Not only must the functionality be retained, the case must be sufficiently robust to withstand the effects of being dropped upon a hard surface; it is a moot point as to whether an employee is more or less careful with an employer provided device. For business continuity reasons, accidental knocks etc must have no effect upon the performance of the device, noting that functionality of a screen of a smartphone must be maintained for, inter alia, and business continuity reasons. The mechanical ruggedness of a case will be paramount in importance for engineers, surveyors and for employees who work outside and in engineering situations; equally for healthcare professionals, such physical ruggedness will need to be supplemented by an ability to be cleaned, autoclaved and to have a reduced capability to transfer dirt and disease arising from contact with foreign bodies, splashes and the like.

US2018249799 (Otter Products LLC) teaches of a protective enclosure for an electronic device, which protective enclosure is configured such that the electronic device can fit within the protective enclosure and be protected from drops, shocks, damage, misuse, and the like. The enclosure comprises a “clamshell” housing for receiving an electronic device. GB2500943 (Paramount Medical Solutions) provides an enclosure comprises a “clamshell” housing for receiving a non-sterile electronic device. The clamshell housing comprises: a first part for receiving the electronic device, a second part whereby the first part can be closed off, and fastening means used to connect the first and second parts, thereby to retain the first part in its closed-off state. The clamshell comprises a flexible, non-rigid material—such as a PET, PE or PVC material—which allows the display and the one or more operating elements of the electronic device to be reliably viewed and operated. Whilst this system can be cleaned, it is provided with a plastics screen that can be scratched in use resulting in a reduced functionality. Adoption of this device has not been widespread.

### OBJECT OF THE INVENTION

The present invention seeks to provide a solution to the problems addressed above. The present invention seeks to provide a smartphone enclosure that can be readily used in a medical environment, be easily and reliably cleaned by aseptic techniques whereby to minimize the possibility that microorganisms remain associated with an enclosure.

Furthermore, the present invention seeks to provide an enclosure that does not impede any functionality of smartphone control, via screen manipulation and/or switches whilst maintaining providing a fully waterproof enclosure i.e. to IP 65, IP 64 or other suitable standards, that can be sterilised by way of infection control chemicals or wipes or using newer sterilisation techniques such as UV Sterilisation or low temperature sterilisation, including the ability to be autoclaved.

### STATEMENT OF INVENTION

In a general sense, there is provided an enclosure for a smartphone device having a flat screen display, the enclosure comprising first and second body members which are removably coupled together, to define a cavity therein for the placement of a communications device therein.

In accordance with a first aspect of the invention, there is provided an enclosure for a communications device having a flat screen display, the enclosure comprising first and second body members operably defining a closed, generally rectangular-prism cavity for the placement of a communications device therein, the first and second body members each being provided with peripheral opposing mating surfaces; wherein the first body member of the enclosure is formed of a rigid material and comprises a substantially rectangular frame about a transparent planar screen, defining a primary axis, with side walls depending from an inside surface of the member along a first end and two parallel sides, to define an open “C”-section aperture; wherein the second body member of the enclosure is formed from a rigid material and comprises a substantially rectangular panel having an outside surface and an inside surface, one end defining a tongue-like element for reception within the “C”-section of the first body member, the other end forming an end member opposite the first end with side walls upstanding from an inside surface, to extend in an overlapping fashion with respect to the first member; wherein the side and end walls of first and second body members, when brought together provide a circumferential wall to the enclosure, which walls are provided with outwardly extending elastic shock absorbing portions; Wherein the inside surfaces of the parallel upstanding sidewalls of the first member provide opposing channel engagement means to provide an entrance portion for the tabs to be inserted in a state of incomplete overlap of the two body members, to permit the tabs to move parallel with the main axis towards a state of overlap of the two members; wherein the channel further comprises abutment members operable to abut against engagement projection members of the second member and wherein the abutment members are shaped to engage with the tabs and cause the second body to be brought toward the first body as the two members fully overlap; Wherein a locking mechanism is provided to enable the first and second body members in a fixed relative position once fully overlapped. Thus, there is provided an enclosure that provides a robust enclosure for a communications device.

Conveniently, the enclosure has first and second body members manufactured from a plastics moulding, such as a medical grade resinous plastics polycarbonate. Elastic shock absorbing properties can be provided by a plastics material such as a thermoplastics elastomer of the types such as a styrene-ethylene butylene-styrene thermoplastics elastomer, preferably provided as an over-moulded feature.

A plastics enclosure can be provided with anti-bacterial/antiseptic properties. The enclosure is conveniently generally rectangular-shaped, having a thickness determined by the thickness of the basic communications device, which may be provided with compartments for the provision of electrical cells to provide additional functionality. Accordingly, the enclosure can be readily used in a medical environment, be easily and reliably cleaned by aseptic techniques is minimize the possibility that microorganisms remain associated with an enclosure.

Conveniently, the enclosure comprises first and second members and each of first and second members have a tongue portion which is received in a correspondingly shaped portion of the respective other member, whereby to sealingly engage in a mated position. A detent or a ramp-like feature can be provided, whereby to enable the two members to remain in a mated position. Conveniently, there is provided a gasket member that enables the mutually contacting surfaces between the two housing members to sealingly engage together. The gasket can be provided as a separate gasket member, which is manufactured from a plastics rubber such as silicone rubber, which possesses an excellent resistance to temperature, ozone and weathering. Nitrile rubbers can be provided where the enclosure would be subject to fuel, oil, aromatic solvents and alcohols. Alternatively, the gasket could be defined at the same time that an over-mould process for protective elements is provided. Accordingly, there can be provided an enclosure that provides a robust waterproof and fluidproof enclosure.

The enclosure lends itself to extension of the basic data storage and transfer capabilities of the communications device. The camera can be adapted to read bar-codes whether of the traditional linear style or of the two-dimensional format. In another embodiment, there can be provided a speculum to locate over the rear facing camera of the communications device, whereby to provide an operation otoscope. A further feature of the invention can be the provision of a single housing electrical cell re-charge facility.

Thus the present invention provides a rugged case or enclosure for a communications device having a display, such as a smartphone and the like. The rigid material can one of a number of materials, but it will be appreciated that a plastics moulding that can be easily and simply mass produced. Inventor has determined that polycarbonate resinous materials can be provided with suitable characteristics. In particular, one such plastics material that is readily available is Makrolon® which is available from Bayer AG, which material has been used for over fifty years and is a well-known material, having a high flexural rigidity and has been used in many industries, including the food preparation and healthcare industries, with known and approved (e.g. FDA) characteristics. Makrolon benefits from its ability to be manufactured reliably with high tolerances and can be autoclaved and, importantly, has a high resistance to all commonly used antiseptic agents, such as high concentration bleach or sporacidal sprays.

The elastic shock absorbing plastics material can conveniently comprise a thermoplastics elastomer, whereby over-moulding manufacturing processes can be employed, whereby to provide a housing that has a finish that can be easily cleaned—and optionally sterilised—and does not have gaps between the two plastics materials, which would otherwise be susceptible of harbouring dirt and germs. Inventor has determined that styrene-ethylene butylene-styrene thermoplastics elastomer, sold under the trade name Evoprene™, can provide not only suitable levels of shock absorption but also adheres well to Makrolon. Additionally, many plastics are easily provided with specific chemicals to provide a range of finished colours.

In common with electronics devices, such as a smartphone, the enclosure is generally rectangular-shaped, having a thickness determined to a large degree by the thickness of the electronics device, although the cavity may be provided with storage compartments for additional functionality. Conveniently, when the first and second members are brought together, there is effectively no space therebetween, whereby no dirt and contaminants can reside, which is important generally and specifically with regard to use of the housing in healthcare facilities and laboratories.

Conveniently, there is provided a separate gasket member, which is manufactured from a plastics rubber such as silicone rubber, which possesses an excellent resistance to temperature, ozone and weathering. Nitrile rubbers can be provided where the enclosure would be subject to fuel, oil, aromatic solvents and alcohols. Alternatively, the gasket could be defined at the same time that the overmoulded elements are provided.

The screen of the housing can be made from a number of materials, for example form a polycarbonate screen or a silicon screen. A further benefit of the present invention, in having rigid first and second housing members is that the screen for viewing the display can be manufactured form a glass without fear of the glass cracking due to an inherent flexibility of the enclosure. Inventor has determined that glasses made using a high-ion exchange process, such as Asahi Dragontrail™ glass, Schott's Xensation™ glass or Corning's Gorilla™ glass can provide glass that is suitably scratch resistant and This type of glass—alumina-silicate glass benefits from being capable of being manufactured using float processing techniques and is readily available in thicknesses of 0.3-5 mm, although other thicknesses available.

A stiff material needs more force to deform compared to a soft material. The Young's modulus of a material is a measure of the stiffness of a solid material, noting that the strength of material is the amount of force it can withstand and still recover its original shape. The geometric stiffness of a product depends on its shape, whilst the hardness of a material defines the relative resistance that its surface imposes against the penetration of a harder body. In contrast, the; flexible cases as have been employed hitherto cannot provide a required degree of rigidity to prevent flexural cracking of glass. Notwithstanding this, plastic films may be provided over the glass to contain any shards in the unlikely event that the glass shatters.

Conveniently, the first and second housings, the overmoulded elastomers and the glass can provide an anti-bacterial effect, to minimise risk of contamination and spread of disease, which is especial benefit when an enclosure in accordance with the present invention is employed by healthcare professionals. Conveniently the screen, whether plastics or glass is adhesively attached by means of a glue gasket, conveniently cut by laser, when the peripheral dimensions are complex and intricate. The design of the first housing that retains the glass screen includes a feature to be discarded if necessary, typically if and extreme G-shock is applied to the screen it would break, rendering the entire housing useless, however by making the screen housing discardable, it can be replaced with a spare screen and render the entire case useable again. The intention is the first housing can be replaced by a non-technical clinician easily and with special tools.

### BRIEF DESCRIPTION OF THE FIGURES

For a better understanding of the present invention, reference will now be made, by way of example only, to the Figures as shown in the accompanying drawing sheets, wherein:

FIGS. 1a & 1b show front and rear views of a branded smartphone device;

FIG. 2a illustrates front view of a first embodiment in accordance with the invention in a closed position, with a communications device installed;

FIG. 2b illustrates perspective view from one side of the first embodiment, without communications device, in a closed position;

FIG. 2c illustrates a side perspective view of the first embodiment in a semi-open position;

FIG. 2d illustrates a perspective view of a rear cover of the first embodiment;

FIGS. 2e & 2f illustrate, respectively, side and base views of the cover with out and with extended battery pack in accordance with first and second embodiments of the invention in a closed position;

FIGS. 2g, 2h & 2i illustrate, respectively, first and second closing positions and a final closing position of abutment features associated with the front and rear components in accordance with first and second embodiments of the invention;

FIGS. 3a-3e illustrate steps in the fitment of a communications device in an enclosure in accordance with the present invention;

FIGS. 4a-4f show how a smartphone can be placed within the enclosure in accordance with the invention;

FIGS. 5a, 5b & 5c, detail differences in the enclosure with regard to a standard and extended capacity electrical cell arrangement;

FIGS. 6a and 6b show, respectively, a perspective view of a communication device with cover in accordance with the invention within a first charging station and a side perspective view of the charging cradle;

FIG. 6c shows an alternative single charger;

FIG. 6d shows a perspective view of a multiple device charging station;

FIGS. 7a-7c show how the invention with a blood testing attachment;

FIG. 8 shows a detail feature relating to sound amplification; and,

FIGS. 9a-9c show clinical use of embodiments of the present invention.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

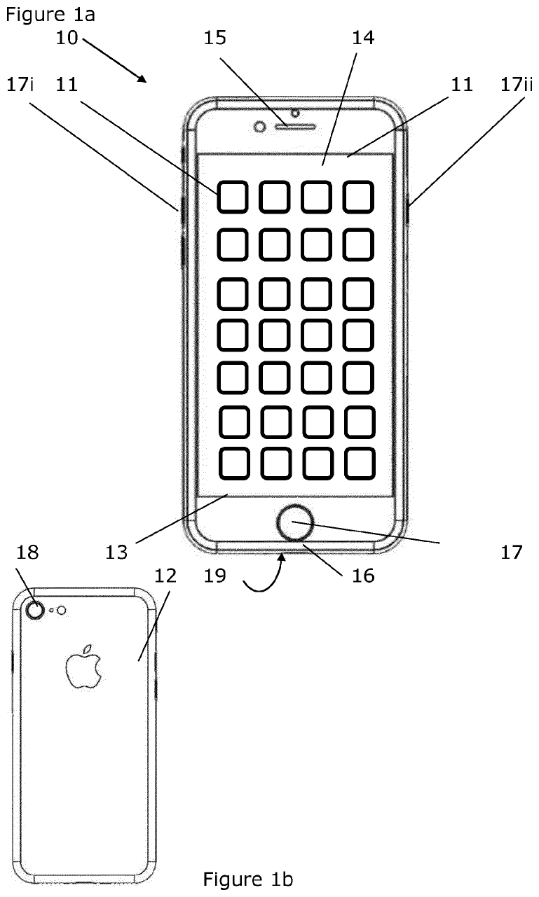

FIGS. 1a and 1a show an example of a smartphone comprising a substantially rectangular shaped “iPhone® 8”, with a front face 11 and a rear face 12, the model “iPhone 8” has a height of 138 mm, a width of 67.3 mm—giving rise to a diagonal length of 6.4″ and a depth—or thickness—of 7.3 mm. A touch screen extends across the front face, from a “bottom” 13 of the screen to a “top” 14 of the screen, with a speaker 15 being placed in a region adjacent the top of the screen. A microphone 16 being placed in the region of a bottom of the front face, adjacent an operational on-off switch 17. This generally corresponds to the placement of speakers and a microphone for receiving aural signals, in common with its phone functionality. On the left hand side of the front face, along the side, towards the top are buttons 17i operable to increase and decrease the volume of the speaker; on the right hand side of the front face, there is a power off switch; whilst at the bottom side of the device, there is a recharge and data transfer socket 19, the recharge and data transfer socket having an insertion axis. It will be appreciated that whilst specific reference is made to the iPhone 8, the design is flexible enough to incorporate the iPhone 7 and the present invention can be provided for the iPhone XS Max 10 and other smartphones as produced by other manufacturers.

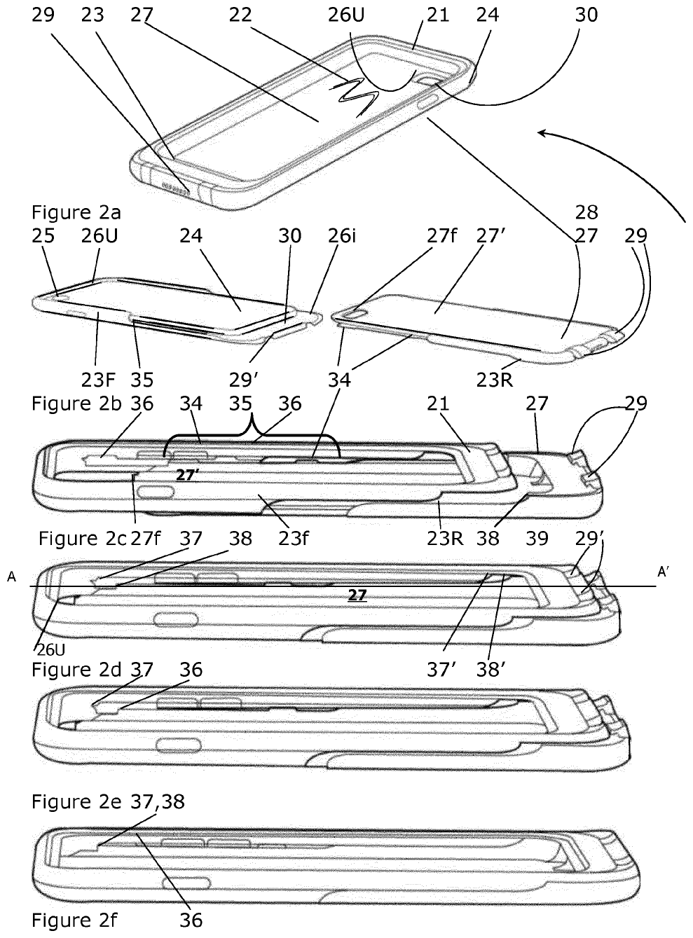

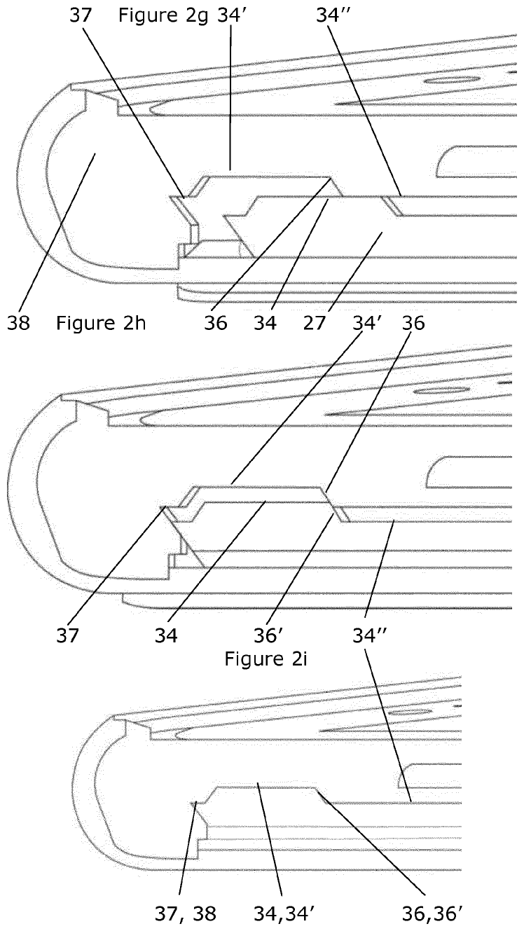

A first embodiment of the invention, comprising an enclosure or housing 20 shall now be discussed with reference to FIGS. 2a-3e. Referring in particular to FIGS. 2a and 2b, showing the enclosure 20 from a front view, a perspective view from one side and in a laterally spaced apart dissembled state, respectively. The two-part construction of enclosure 20 shall be referenced with respect to an upper screen part and a lower screen part—with reference to a screen when in use in portrait orientation. The enclosure comprises a first, front casing panel 21 provided with a screen 22 (indicated by zig-zag) that is surrounded by a frame 23 and a protective peripheral member 24. An underside edge part 25 of the upper frame defines a mating portion 26U against which leading edge 27f of a second, rear casing panel 27 abuts. The rear panel 27 and the frame 23 of the front panel are substantially coextensive in part and meet along a mating peripheral circumferential edge 26. The circumferential edge portion 26L at the mouthpiece and switch position of the device is indicated as being halfway between the upper surface and the lower surface. Switch 28 is activated by capacitive sensing, as is known, through the glass 22. Clips 29 extend from the rear panel and engage with the upper member 21 in a secure fashion, to prevent the two parts of the enclosure, once brought together from separating, both slidingly along a longitudinal axis of the enclosure as a whole and in a sense of the z-axis of the main planes of the two separate components. FIG. 2b shows slide members 34 of the rear panel 27 prior to the rear panel being inserted in a sliding fashion with respect to the front panel 21, with the slide members 34 cooperating with corresponding channels 35 within an inside wall portion 36 of the outside peripheral protective member defined by a front cover circumferential edge portion 23F and the protective circumferential edge 23R. The leading edge 27f of the tongue-like portion 27′ of the rear panel 27 is shown opposite a mating portion 26U of the underside part 25 of the upper frame panel 21. Below the lowermost screen part, clip 29 pivotally connected to the lower frame panel 27 engages with detent portion indicated at 29′ on the upper face to secure the two components once brought together. It should also be mentioned that whilst a charging transfer connector element is not shown, such a connector element within the base portion of the case will be brought to engage with the corresponding charging contacts of the phone when inserted in mating alignment.

FIGS. 2c-e show the enclosure—without a device in place in three stages of approach to secure engagement, with FIG. 2f showing the enclosure components in secure engagement, with closure means in place. Referring firstly to FIG. 2c, tabs 34 slide within inside channel 35 of the upper enclosure member, which channel is provided with detent portions 36 for placement of the tabs 34 once closed. Obviously, the width of separation of the channels correspond, for mutual abutment, with the tabs 34 on either side of the base cover 27. With reference to FIG. 2d, it can be seen how first and second secondary engagement means situated at the upper part of the screen comprising an abutment members 37, 37′ and engagement projection members 38, 38′ urge the two parallel separated cover portions 21 and 27 to become closer together both in a parallel-plane sense and in an axial longitudinal sense, as indicated in FIGS. 2c-2f. It will be noted that abutment 37 presents a face that is angled to the tab 38: equally detent member 36 provides a correspondingly angled face to enable, in the final approach of closure, the tab 36 to engage therewith whereby to enable the bringing together about the mutual sealing faces of the two enclosure parts, the front panel 21 and the rear panel 27. The angle has been found to work well at 45° to the plane of the case, but it will be appreciated that other angles will also work and it has been found to work if varied between 25° and 65°, noting that the cooperating features will need to be of a complementary angle. Whilst the abutment means 37′ is only generally indicated, it can be seen that projection member 38′ can engage therewith whereby to facilitate the generation of equivalent forces at the base of the enclosure, whereby to provide even forces of engagement as between the two enclosure panels, whereby to provide a sealed enclosure, preventing ingress of dirt and fluids. Reference numeral 26 indicates a sealing edge between the respective protective circumferential edge portions, associated with the rear case panels, which are arranged to provide sealing contact and enable components that are parallel with a top-bottom axis of the housing/phone to slide with respect to each other. FIG. 2f shows the two parts of the enclosure fully received, i.e. the first, front panel and the second, rear panel are slidingly engaged together, connected together by means of a cooperating extending members and slide members, the extending members slidingly engaged within the slide channel, with non-slidingly engaged features being sufficiently resilient to enable a waterproof seal to be achieved as will be discussed in greater detail below.

FIGS. 2g, 2h & 2i illustrate, respectively, first and second closing positions and a final closing position of abutment features associated with the front and rear components in accordance with first and second embodiments of the invention, with a state of closure corresponding to FIGS. 2d, 2e and 2f, being partial sections along line A-A′ per FIG. 2d. With reference to FIG. 2g, it can be seen how first engagement means situated at the upper part of the screen comprising an abutment members 37 and engagement projection members 38 urge the two parallel separated cover portions 21 and 27 to become closer together firstly in an overlapping sense—as the element 34 slides in a single plane across until—as seen in FIG. 2h—the angled trailing portion 34′ of upstanding member 34 of the lower cover portion meets similarly angled feature 36 of the upper cover portion, so as to enable two-axis movement—with the lower portion moving toward the top circumferential edge of the upper portion and the plane of the lower portion approaching more closely the screen of the top portion, as indicated in FIGS. 2c-2f. It will be noted that abutment element 37 presents a face that is angled to the tab 38: equally detent member 36 provides a correspondingly angled face 34′ to enable, in the final approach of closure, the tab 36 to engage with angled face 34′ whereby to enable the bringing together about the mutual sealing faces of the two enclosure parts, the front panel 21 and the rear panel 27. It is important to note that whilst the sliding function is important in the latter stages of the coupling of the two covers, the upstanding element 34 need not abut the underside element 34′ and 34″ as the base cover is inserted into the channel of the retaining mechanism.

With reference to FIGS. 3a and 3b, it can be seen that the fastening clips are, respectively in the closed and open positions, the clips providing a secure retention system, being formed of Makrolon® plastics which provides a degree of resilience to enable a snap-catch element to be fully functional and durable. It will be noted that FIG. 3a has a line A-A′, being a line of cross-section through the enclosure exhibited in FIGS. 3c and 3d, which show how the abutment means 37′ as discussed above presents an angled face to projection member 38′, as the two components are brought together. FIG. 3e shows the projection member about to engage from a perspective view.

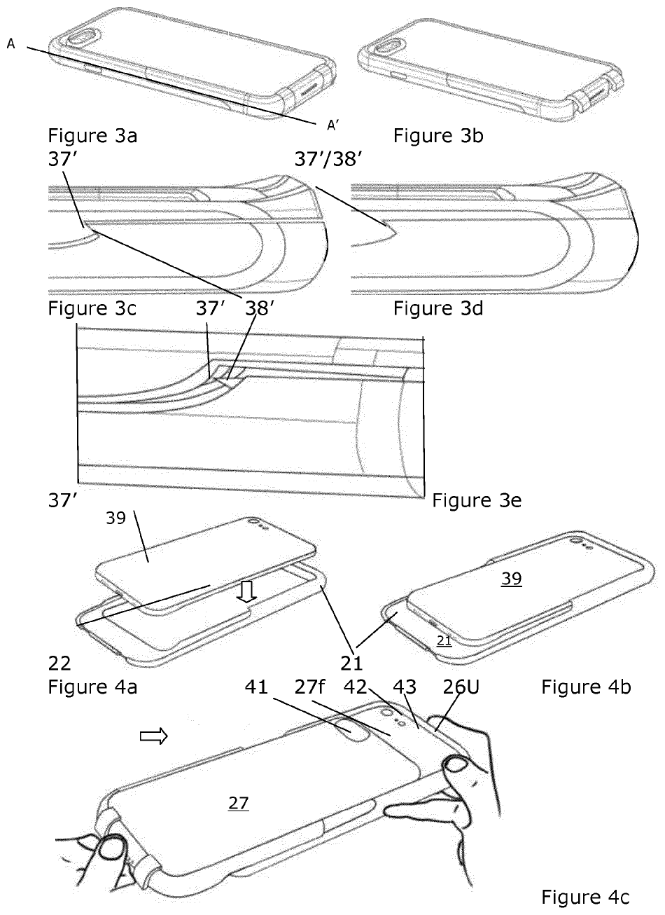

With reference to FIG. 4a, the process steps in the placement of a smartphone 39 or other like device within the housing 20 shall be discussed. The front cover 21 is arranged to permit placement of an input screen 22 of the smartphone 39 against an inside face of the glass, being a particularly scratchproof yet strong glass such as those sold under the Gorilla® brand. The glass of the smartphone is placed upon the inside face 22 of the smartphone such that the capacitive/touch sensitive nature of the smartphone screen is not compromised, noting that once the smartphone 39 has been placed against the inside screen, per FIG. 4b, the smart phone does not move relative to the cover 21. It will be appreciated that any dust or other forms of dirt—such as grease marks are not present on either of such glass surfaces, whereby to prevent scratching and possibly interfering with data input in use, or even causing displayed data to be misinterpreted.

With reference to FIG. 4c, there is shown the placement of the rear cover—by way of a sliding action of the rear cover against the smartphone once placed within, with the outside of the screen abutting the inside face of the of the screen 22 of the front cover. It will be noted that the rear face is provided with a window 44 in a position such that a camera lens 42 and any further sensor 43 is fully operational, further noting that the inside face of the window must also be free from dirt, grease etc. to ensure that the light levels for photographs etc. are correct and that any image is not distorted or otherwise interfered by such dirt.

Once the edge 27f is brought against lower edge element 26U and the respective sealing elements brought against each other and the clip 29 is engaged in recess 37, then the two upper and lower housing components are sealed against water ingress and impact damage, as may be encountered if, for example, the device is dropped onto a hard floor etc.

With reference to FIGS. 4d and 4e, it has been found helpful to have a resilient member 27ii placed upon the inside rear face 27i of the rear cover 39 to act upon the rear face of the smartphone. The resilient member 27ii is conveniently formed from a polymer foam plastics or similar and is conveniently retained within ribbing elements 27iii, which assist in location and assist in the provision of greater rigidity to the rear surface. The resilient member can take the form of various shapes. Indeed, the resilient member can take different forms such as a spring steel arrangement, as would be known to a skilled man. It has also been found that the ribbing elements upon the inside rear face of the rear cover prevent deformation thereof, to ensure that the screen of the smartphone is held against the inside of the screen 22 of the upper cover panel 21 of the enclosure. FIG. 4f shows how a device is placed within the first and second cover components of the enclosure prior to the bringing together of such components. This figure also shows the position of a power button 32, which in this case, corresponds with the position of a power button for an iPhone. To assist in the functioning of the button—which is depressed with respect to the surface of the screen and has an inwardly curved surface, the underside of the screen 22 has an inwardly extending feature which has a corresponding upstanding element of a reduced diameter with respect to the power button, yet has a height in correspondence with the depth of the power button of the device whereby operation of the button through depression of the screen is possible, even though the screen is glass, since high ion exchange glasses, typically with a Young's modulus in the range of 65-85 kNmm⁻², when provided in a thickness in the range of 0.5-1.5 mm can easily be depressed to provide a pressure-based operational functionality to the button.

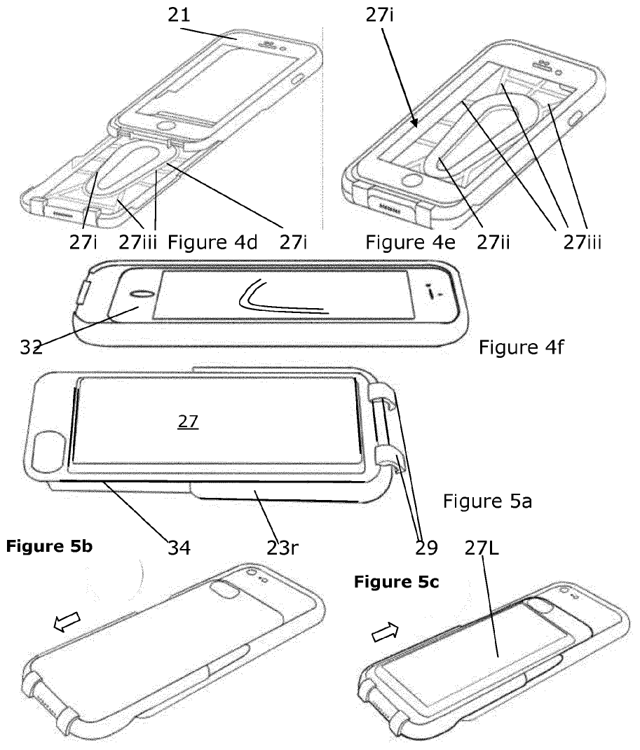

FIGS. 5a, 5b & 5c, detail differences in the enclosure with regard to a standard and extended capacity electrical cell arrangement. In FIG. 5a, the rear shell 27 is provided with a larger, outwardly extending protrusion, which increases the internal volume for an electrical cell or battery of cells, to increase an operational period. FIG. 5b shows how a standard rear cover can be removed in the direction of the arrow, to be replaced with a larger rear cover 27L, as shown in FIG. 5c

Returning to FIG. 2a and with reference to FIGS. 2b-2d, the two front and rear panels 21, 27 mate together to fully enclose a device once the front and rear panels have been brought fully home together. Volume controls associated with a smartphone can be operated by providing corresponding push-button actuators on the sides of the enclosure. Other controls, for example a power on/off switch of a device can be accessed with similar mechanisms, whilst a power/data transfer port could also be provided, being associated with an inside face of the lower support assembly and connected with a male plug member corresponding to the data transfer socket of a device to be protected by the housing. There is a further glazed screen 30 arranged about an aperture 26i defined in rear part of front panel 24. Screen 30 is provided to enable a camera associated with a rear face of an electronic device to take images through the rear face of the enclosure. The camera window glass need not be of the same type as the display screen's glass, although conveniently may be so, and could comprise a suitable scratch resistant plastics material. Notwithstanding the type of material, the camera window needs to be affixed so that the adhesive fixing provides suitable degree of tolerance to thermal changes, shock and resist the conditions present in sterilising equipment.

The front and rear panels 21, 25 are conveniently formed from a relatively rigid material, whereby when formed they substantially resist deformation. It has been determined that polycarbonate resinous materials can be provided with suitable characteristics. In particular, one readily available plastics material is Makrolon® in the name of Bayer, which has been used for over fifty years and is a well-known material, having a high flexural rigidity (Flexural Modulus of 2.4 GPa), and has been used in many industries, including the food preparation and healthcare industries, with well-defined characteristics; it can be manufactured reliably with high tolerances and can be autoclaved and, importantly, has a high resistance to all commonly used antiseptic agents. Inventor has found that by employing a rigid enclosure, the screen can be provided by high ion exchange glasses with typical values of a Young's modulus being of the order of 70-80 GPa, Vicker's Hardness being of the order of 600-800 kgf/mm2, preferably 665-685 kgf/mm², Fracture Toughness being of the order of 0.6-0.8 MPa m^{0.5} Furthermore, glass produced using high ion exchange process can have anti-microbial coatings applied, such as silver ion and copper ion coatings, which are commonly used, although other metals such as the noble metals (including gold and platinum) can also be employed. Of the metallic ions with anti-microbial properties (i.e. they provide oligodynamic action), silver is perhaps the best known due to its unusually good bioactivity at low concentrations. It is well known that glasses provide substantially greater resistance to scratching compared with plastics screens. It will be appreciated that there are a number of other plastics manufacturers: for example, Inventor has employed polyurethanes as manufactured form PORON Industrial Polyurethanes to provide durable, long-term performance plastics operable in a products being rigid yet providing good sealing qualities with complementary products enabling sealing and cushioning or vibration management that will not become brittle and crumble. A further benefit in the use of a rigid material for the manufacture of the enclosure, Applicants have determined that the sealing qualities between the first and second panels are extremely good, with the inside faces of the sealing edge presenting minimal edge separation, whereby the harbouring of dirt (and germs) is effectively substantially reduced with regard to any known enclosures. In order to provide this sealing effect, care has been taken to ensure that the hinges ensure closure and assist in lateral rigidity. It is also pertinent to point out that the choice of material of construction must not substantially impair transmission of wifi communications as between a communications device 10 retained by the housing. Different devices will have their wifi antenna arranged in different configurations, as will be appreciated.

Inventors have thus designed the enclosure such that the screen can be made from scratch resistant glasses, such as toughened glass, in particular glasses made using a high-ion exchange process, such as Asahi Dragontrail™ glass, Schott's Xensation™ glass or Corning's Gorilla™ glass. This type of glass—alumina-silicate glass—benefits from being capable of being manufactured using float processing techniques and is readily available in thicknesses of 0.5-5 mm, although other thicknesses available. It has been found that such glass with a thickness of 0.7 mm has provided sufficient for manufacturing and use; as a precaution, a 0.12 mm anti-shatter film can be advantageously provided, where a degree of security from glass shards being spread in the unlikely event that the limits of structural integrity of the glass are exceeded, noting that insurance providers frequently stipulate the provision of such materials in, for example, medical environments. Notwithstanding this, it will be inevitable that a glass will become damaged by accident. Inventor has configured the glass such that the glass can be separated through the use of suitable solvents, whereby a polymeric seating gasket and adhesive can be removed from the front cover 21 and a replacement glass and seal. It is anticipated that this would be performed by users but a refurbishment service could also be offered.

It will be appreciated that in particular environment, regard will be had to the operating conditions; whilst polycarbonates such as Makrolon are resistant to mineral acids (even in high concentrations), a large number of organic acids, many oxidizing and reducing agents, neutral and acidic saline solutions, some greases and oils, saturated aliphatic and cycloaliphatic hydrocarbons, and most alcohols, certain operating circumstances may dictate that other specific material choices may be made. Conveniently, the plastics and resins contain an internal mould release additive. Further, many plastics and resins are available in natural, clear tints, select transparent, translucent, opaque colours and special effects.

Inventors have determined that one type of styrene-ethylene butylene-styrene thermoplastics elastomer, sold under the trade name Evoprene™, can provide not only suitable levels of shock absorption but also adheres well to Makrolon. Indeed, these polymers are fully saturated so the resistance to oxidation, ozone and general outdoor weathering is excellent. Evoprene™ Standard Compounds are easy to mould/process on standard thermoplastic processing equipment and similar materials with the same mechanical/chemical properties are envisaged. Whilst the embodiment of FIGS. 3a-3d show resilient member 23 provided on the outwardly extending circumferential edges of the case, providing, in particular, protection for the four corners of the enclosure, it would be possible to have a layer of this material provided on all external surfaces. In addition to the chemical bonding, mechanical keying features are provided to ensure that the compound remains associated with the casings. Evoprene™ further benefits from being easy to colour and is free from phthalate or similar plasticisers.

It will be apparent to those skilled that the rigidity of the housing provides benefits in that the screen of the electronic device 20 can be placed in an abutting relationship with an inside face of the screen, whereby the capacitive touch technology employed by most smartphone providers is not compromised by the housing screen glass, which also enables capacitive touch technology to be maintained. It will be appreciated that when an electronic device is placed within the enclosure of the present invention, upon closure of the housing elements, the base member is provided with resilient elements which act against the rear of the device, whereby the screen of the device is in touching contact with the inside face of the enclosure screen 22. The glass can be adhesively mounted to the Makrolon, but it has been found that a double-sided polyethylene foam tape 34 can be employed. The thickness can be of the order of 0.5 mm and an acrylic adhesive treated to provide a high degree of tack can be employed. Such foam tapes are widely available since they are presently used in a number of diverse applications such as mirror attachment applications, trim fitment to white goods etc; furthermore, they can also resist the high temperatures as used in sterilising equipment—for example, Tesa Tape Inc of Charlotte USA or 3M specialised gaskets provides a wide range of adhesive tapes/gaskets. Conveniently, the material is provided in planar form and is cut using laser cutting techniques or similar, to ensure that the attachment is consistent in quality.

As is known, many communications devices, such as the iPhone 8 are designed to be controlled by bare fingers. The present invention, through the use of a glass such as a high ion exchange glass can enable control of the device though the use of gestures and the like, enabling effective capacitive functioning of the screen of the device. Importantly, such capacitive control can be maintained despite use of surgical gloves. Surgical gloves have more precise sizing with a better precision and sensitivity and are generally made to a higher standard than for general medical gloves, being disposable gloves used during medical examinations and procedures that help prevent contamination between caregivers and patients.

The mating seal 34 or gasket can be made from a number of different materials, such as silicone rubber, which possess an excellent resistance to temperature, ozone and weathering. Silicone rubbers can easily be manufactured from FDA approved materials and also provides good insulation (electrical) properties but poor resistance to petroleum based fluids. Nitrile rubbers can be provided where the enclosure would be subject to fuel, oil, aromatic solvents and alcohols. Nitrile rubbers benefit from being rugged and have high tear strength and abrasion resistance, but suffer from ozone exposure and low temperature performance. In a further alternative, the gasket could be defined at the same time that the overmoulded elements are provided. Whilst this might assist in the manufacture of the enclosure, by simplifying the number of manufacturing/assembly steps, in the event of damage, the gaskets would not be easily be replaced.

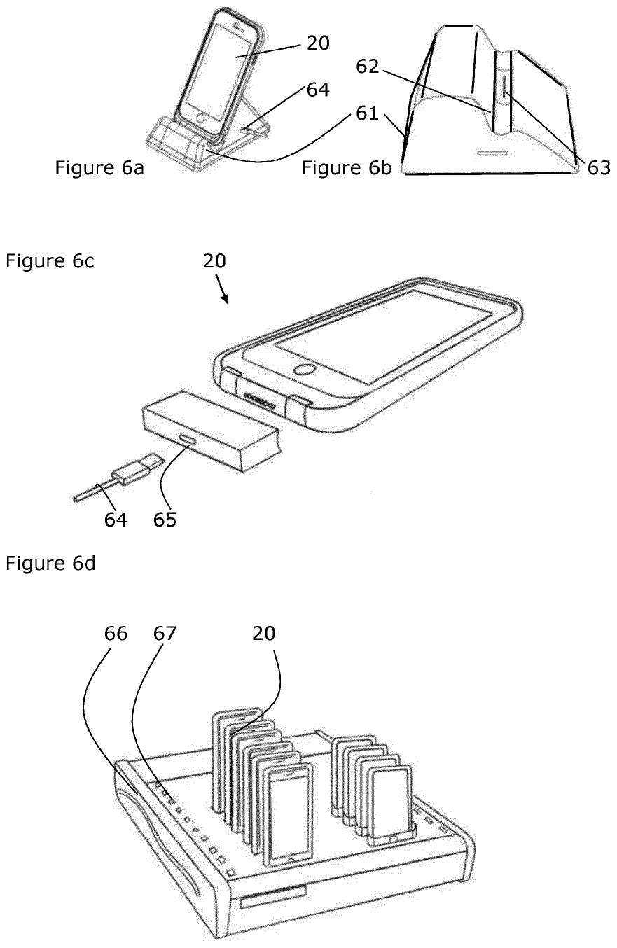

FIG. 6a shows a first charging station, of ruse with only a single housing 20 communication device. The stand 61, shown in more detail in FIG. 6b, conceals a magnetic element indicated in the area 62 to assist in keeping the housing 20 in place, permitting wireless charging to take place. In certain embodiments, region 63 could make contact with data transfer pins 29 for data transfer or alternatively provide direct current when wireless functionality not enabled. FIG. 6c shows an alternative single adapter unit 65 micro-USB (Apple-style) between an enclosure 20 in accordance with the invention and a micro-USB (Apple style) lead 64, the adapter unit converting signals from the Micro-USB to an 8 pin male docking element associated with the enclosure 20. FIG. 6d shows a hospital ward docking station 66 providing slots 67 to permit enclosures with device 20 to be charged or simply the rear enclosures 25 of the second embodiment wherein a the back-up/extended duration electrical cells can be charged, to subsequently enable housings with fully charged electrical cells to be swapped to assist personnel actively using the communications device enclosures.

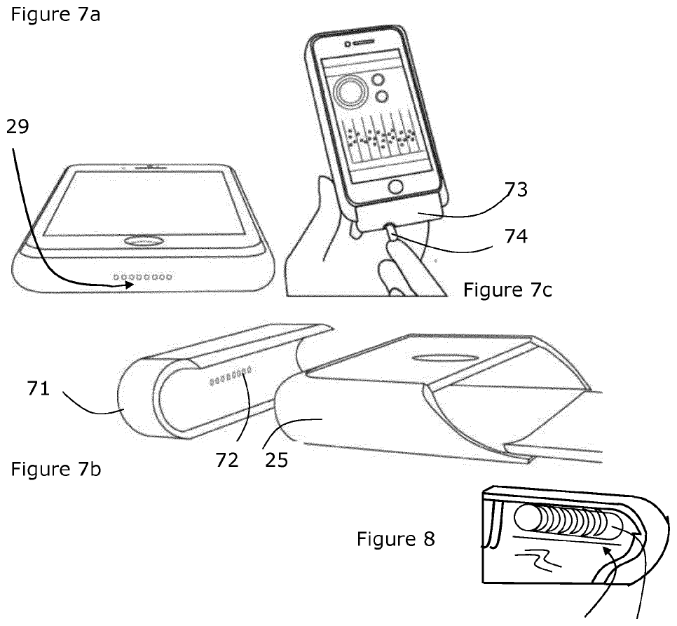

FIGS. 7a-7c shows the lower edge portion of enclosure 20 associated with a further type of adapter unit 71 with a blood test unit, adapted to receive paper blood test strip 72 via port 73, as are often used for conditions such as diabetes. Unit 71 is an add-on feature connected with the enclosure by way of high power magnets (not shown). FIG. 7c shows the add-on feature 71 receiving a paper strip 72 for blood testing with a finger 74. Other bodily fluid tests can be tested e.g. sputum, etc. for other conditions, such as virus testing e.g. C-19.

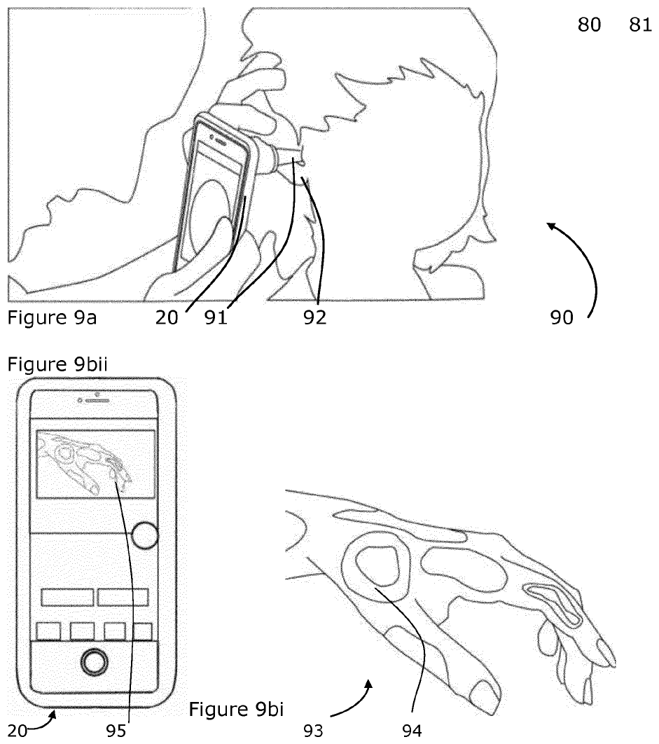

FIG. 8 shows a detail in the base, where a number of channels 81 have been found to direct and amplify sound to the microphone of the communications device.

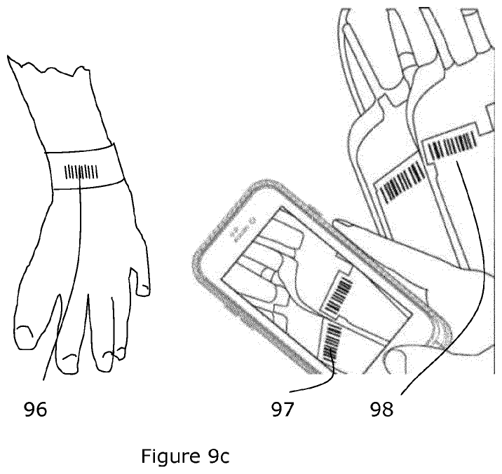

FIG. 9a shows a still further embodiment, wherein an enclosure in accordance with the present invention 20 is provided with a speculum 91 (i.e. an otoscope extension) which attaches to the glazed section of the rear cover 27, where the camera and light source therefor are arranged. The otoscope should be held in the hand of the same side as the ear 92 to be examined of the patient 90 and this permits the other hand to rest the upon a patient's temple.

FIG. 9bi shows a hand 93 of a patient presenting a lesion 94. The present invention enables a communications device 10 enclosed by the housing 20 to safely record a skin condition. Given that such a condition may be infectious, the present invention can reduce the risk of infection of other by providing contamination by providing an enclosure that is wholly capable of being sterilized, as shown in FIG. 9b. FIG. 9c shows how a correlation can be made with a patient—identified by way of a bar-code wrist band 96 is provided with a blood supply 98 identified by a bar-code, which data is entered in a communications device 10 enclosed by a housing in accordance with the present invention. It will be appreciated that individual patient data and treatment can be correlated using a device in accordance with the present invention.

The present invention thus provides a rugged enclosure for smartphone devices. It will be appreciated that the rigid design can provide effective shock absorption from incidents that are likely to happen in general usage. Different designs of smartphone—if of similar general sizes can be accommodated with one enclosure; padding being provided not only to enable differ thicknesses of devices, but also to prevent lateral movement of a device once placed within the enclosure. It is expected that in certain institutions, the smartphones will be provided by the operating body; however, in other institutions, smartphones may be the personal property of specific users. By the provision of a cleaning department in a hospital or other healthcare facility, a pharmacy and pharmacological environments and food preparation areas, standards of cleanliness can be monitored and maintained. The present invention by the use of a rigid body with slide-to-close features can reliably prevent ingress of water into an enclosure, once closed and accordingly, it will be appreciated that the enclosure can be employed in many other environments where use of a smartphone is required, but that such use in an unprotected environment can destroy the i/o ports, switches etc. Thus the present invention can be safely employed in many engineering situations from water processing plants, engineering works, forestry and in fisheries and outdoor research facilities. Furthermore the present invention can be applied in several marine areas, including research, whilst military versions (including casualty evacuation scenarios) are also envisioned. Lanyards may be adopted such that they can connect with the handle, for example, such that loss in an outdoor environment or to prevent damage from significant drops can be prevented.

1. An enclosure for a communications device having a flat screen display, the enclosure comprising first and second body members operably defining a closed, generally rectangular-prism cavity for the placement of a communications device therein, the first and second body members each being provided with peripheral opposing mating surfaces;
wherein the first body member of the enclosure is formed of a rigid material and comprises a substantially rectangular frame about a transparent planar screen, defining a primary axis, with side walls depending from an inside surface of the member along a first end and two parallel sides, to define an open “C”-section aperture;
wherein the second body member of the enclosure is formed from a rigid material and comprises a substantially rectangular panel having an outside surface and an inside surface, one end defining a tongue-like element for reception within the “C”-section of the first body member, the other end forming an end member opposite the first end with side walls upstanding from an inside surface, to extend in an overlapping fashion with respect to the first member;
wherein the side and end walls of first and second body members, when brought together provide a circumferential wall to the enclosure, which walls are provided with outwardly extending elastic shock absorbing portions;
Wherein the inside surfaces of the parallel upstanding sidewalls of the first member provide opposing channel engagement means to provide an entrance portion for the tabs to be inserted in a state of incomplete overlap of the two body members, to permit the tabs to move parallel with the main axis towards a state of overlap of the two members;
wherein the channel further comprises abutment members 37, 37′ operable to abut against engagement projection members 38, 38′ of the second member and wherein the abutment members are shaped to engage with the tabs and cause the second body to be brought toward the first body as the two members fully overlap;
Wherein a locking mechanism 29 is provided to enable the first and second body members in a fixed relative position once fully overlapped.

2. An enclosure according to claim 1, wherein the first and second body members are manufactured from a plastics moulding.

3. An enclosure according to claim 2, wherein the first and second body members are manufactured from a resinous plastics polycarbonate.

4. An enclosure according to claim 1, wherein the elastic shock absorbing plastics material comprises a thermoplastics elastomer.

5. An enclosure according to claim 1, wherein the elastic shock absorbing plastics material comprises a styrene-ethylene butylene-styrene thermoplastics elastomer.

6. An enclosure according to claim 1, wherein the elastic shock absorbing plastics material comprises a thermoplastics elastomer which is provided as an over-moulded feature.

7. An enclosure according to claim 1, wherein the slide means roll with respect to the track and comprise rotatable rollers.

8. An enclosure according to claim 1, wherein the plastics materials of the enclosure are treated to provide anti-bacterial/antiseptic properties.

9. An enclosure according to claim 1, wherein the opposed mating surfaces having a continuous seal member whereby to provide sealing engagement when coupled together.

10. An enclosure according to claim 1, wherein the enclosure is generally rectangular-shaped, having a thickness determined by the thickness of the electronics device.

11. An enclosure according to claim 1, wherein the enclosure is provided with compartments for the provision of electrical cells to provide additional functionality.

12. An enclosure according to claim 1, wherein the enclosure comprises first and second members and each of first and second members have a tongue portion which is received in a correspondingly shaped portion of the respective other member, whereby to sealingly engage in a mated position.

13. An enclosure according to claim 1, wherein there is provided a speculum to locate over a rear facing camera of the communications device, whereby to provide an operational otoscope.

14. An enclosure according to claim 1, wherein the two members are provided with a locking mechanism whereby to enable the two members to remain in a mated position.

15. An enclosure according to claim 1, wherein the opposed mating surfaces having a continuous seal member whereby to provide sealing engagement when coupled together, which seal member is manufactured from a separate plastics rubber such as silicone rubber or nitrile rubbers or is integrally overmoulded with the housing members.

16. An enclosure according to claim 1, wherein the screen is selected from a material such as a polycarbonate plastics, a silicon plastics or a high ion exchange glass.

17. An enclosure according to claim 1, wherein the inside rear screen is provided with a resilient member operable to act on the rear face of a communications device, whereby to ensure that a flat screen display of the communications device abut in close proximity to the inside face of the screen of the enclosure.

18. An enclosure according to claim 1, wherein the inside rear screen is provided with ridges to improve rigidity of the rear cover.
